(19) United States
(12) Patent Application Publication
(10) Pub. No.: US 2009/0109250 A1
(43) Pub. Date: Apr. 30, 2009

(54) METHOD AND APPARATUS FOR SUPPORTING A SUBSTRATE

(76) Inventors: Benjamin M. Johnston, Los Gatos, CA (US); Michael Renta, Campbell, CA (US)

Correspondence Address: DUGAN & DUGAN, PC, 245 Saw Mill River Road, Suite 309, Hawthorne, NY, 10532, US

(21) Appl. No.: 11/925,729

(22) Filed: Oct. 26, 2007

(51) Int. Cl. B65H 1/00; B41J 2/01

(52) U.S. Cl. 347/4; 414/222.01; 414/800

(57) ABSTRACT

Methods and apparatus for supporting a substrate are provided. According to one aspect of the invention, a substrate support is provided which includes a first major surface comprising a plurality of flat support tiles and a plurality of leveling mechanisms coupled to the plurality of support tiles, wherein the plurality of leveling mechanisms are adapted to level the plurality of flat support tiles with respect to each other so as to provide a flat and level first major surface of the substrate support. Numerous other aspects are provided.

### CROSS-REFERENCE TO RELATED APPLICATIONS

The present application is related to the following commonly-assigned, co-pending U.S. Patent Applications, each of which is hereby incorporated herein by reference in its entirety for all purposes:

U.S. patent application Ser. No. 10/781,953 filed Feb. 19, 2004 and entitled “METHODS AND APPARATUS FOR POSITIONING A SUBSTRATE RELATIVE TO A SUPPORT STAGE” (Attorney Docket No. 8166);

U.S. patent application Ser. No. 11/212,043 filed Aug. 25, 2005 and entitled “METHODS AND APPARATUS FOR ALIGNING INKJET PRINT HEAD SUPPORTS” (Attorney Docket No. 9521-6);

U.S. patent application Ser. No. 11/521,177 filed Sep. 13, 2006 and entitled “METHOD AND APPARATUS FOR MANUFACTURING A PIXEL MATRIX OF A COLOR FILTER FOR A FLAT PANEL DISPLAY” (Attorney Docket No. 10502); and

U.S. patent application Ser. No. 11/761,832 filed Jun. 12, 2007 and entitled “METHOD AND APPARATUS FOR DEPOSITING INK ONTO SUBSTRATES” (Attorney Docket No. 11127).

### FIELD OF THE INVENTION

The present invention relates to equipment for handling substrates used in the manufacture of color filters for flat panel displays, and more particular, to methods and apparatus for supporting a substrate.

### BACKGROUND

Inkjet printing systems are being employed in numerous applications including the manufacture of color filters for flat panel displays (FPDs). In color filter manufacture, ink is jetted onto a matrix formed on a substrate, such as a panel made of glass or polymer. Conventionally, FPDs are produced on standard-sized substrates, such as ‘20K’ substrates, having surface dimensions on the order of 1300 mm by 1500 mm. A number of inkjet printer systems have been configured to accommodate substrates of this size.

Seventh generation TFT-LCD substrates measure approximately 1,800 mm×2,200 mm (1.8 meters×2.2 meters) and can produce up to eight 40-inch or six 46-inch display objects (e.g., large-screen TV panels) per substrate. The next generations of FPDs in development and future generations are intended to have considerably larger display sizes. These larger FPDs are to be produced on correspondingly larger standard substrates. For example, a new standard substrate size, referred to as a ‘60K’, has surface dimensions on the order of 2600 mm by 2300 mm.

Conventional inkjet printing systems configured to operate on 20K substrates may not be able to accommodate the larger 60K substrates effectively. In particular, the support stage upon which substrates are mounted in such systems may not be able to support 60K substrates at all in some cases, and in other cases, may do so in a sub-optimal or ineffective way. Inkjet printing systems that can accommodate the next generation 60K substrates would be desirable.

### SUMMARY OF THE INVENTION

In an aspect of the present invention, a substrate support is provided which includes (1) a first major surface comprising a plurality of flat support tiles and (2)

a plurality of leveling mechanisms coupled to the plurality of support tiles, wherein the plurality of leveling mechanisms are adapted to level the plurality of flat support tiles with respect to each other so as to provide a flat and level first major surface of the substrate support.

In a another aspect of the present invention, an inkjet printing system is provided which includes (1) a movable platform, (2) a substrate support coupled to the moving platform which further includes (i) a first major surface comprising a plurality of flat support tiles and (ii) a plurality of leveling mechanisms coupled to the plurality of support tiles, and (3) a plurality of inkjet print heads adapted to deposit ink onto a substrate positioned on the first major surface of the substrate support, wherein the plurality of leveling mechanisms are adapted to level the plurality of flat support tiles with respect to each other so as to provide a flat and level first major surface of the substrate support.

In yet another aspect of the present invention, a method of supporting a substrate is provided which includes (1) providing a plurality of support tiles, each of the plurality of support tiles having an area sufficiently small to enable the support tiles to be flattened, (2) flattening the plurality of support tiles, (3) combining the plurality of flat support tiles so as to form a substrate support, and (4) leveling the plurality of support tiles on the substrate support so as to provide a flat and level major surface of the substrate support.

Other features and aspects of the present invention will become more fully apparent from the following detailed description, the appended claims, and the accompanying drawings.

### BRIEF DESCRIPTION OF THE DRAWINGS

FIG. 1 is a schematic perspective view of an exemplary inkjet printing system in accordance with embodiments of the present invention.

FIG. 2 is a schematic top plan view of an exemplary substrate support in accordance with embodiments of the present invention.

FIG. 3 is a bottom perspective view of an exemplary clamping apparatus in accordance with embodiments of the present invention.

FIG. 4 is a bottom perspective view of the exemplary substrate support in accordance with embodiments of the present invention.

FIG. 5A is a cross-sectional perspective view showing a substrate in a ‘down’ position with respect to the substrate support in accordance with embodiments of the present invention.

FIG. 5B is a cross-sectional perspective view showing a substrate in a ‘up’ position with respect to the substrate support in accordance with embodiments of the present invention.

FIG. 6 is perspective view of an exemplary substrate support and platform in accordance with embodiments of the present invention.

FIG. 7 is cross-sectional view of an exemplary leveling mechanism in accordance with embodiments of the present invention.

### DETAILED DESCRIPTION

In inkjet printing systems, substrates to be printed upon are generally placed and supported on a horizontal platform referred to herein as a substrate support. Substrate supports may not be perfectly level, and as supports are manufactured in larger sizes to support larger substrates, surface anomalies and unevenness may be magnified. Due to the high-resolution and strict tolerances employed in current inkjet printing processes, total height differences along the surface of the substrate support on the order of 25 microns or greater may cause inaccuracies in printing operations if not corrected or compensated for.

To support large substrates (e.g., 60K substrates), an inventive substrate support comprises a plurality of sections or divisions, referred to herein as support tiles. While the entire surface area of the substrate support may be too large to machine (‘flatten’), each of the component support tiles of which the substrate support is formed may be small enough to machine to a high level of flatness. The flattened support tiles may be independently leveled with respect to each other after being installed on the substrate support to provide a uniform substrate support surface. The inventors of the present invention have found that independent leveling of flattened support tiles allows 25 micron tolerances to be achieved.

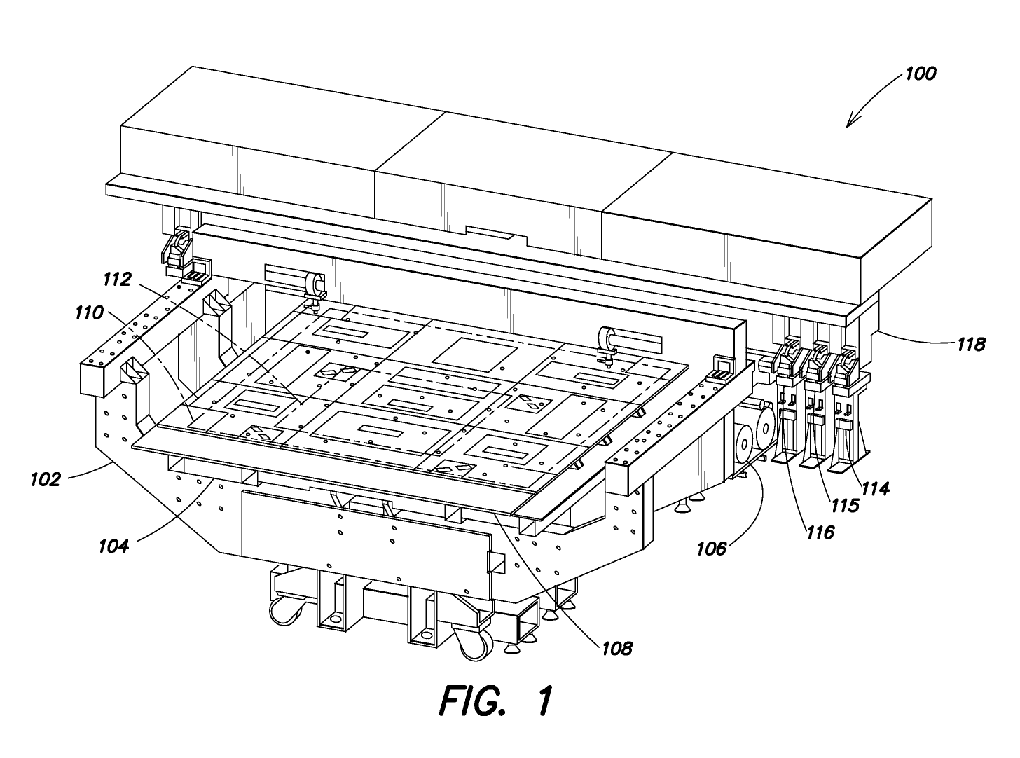

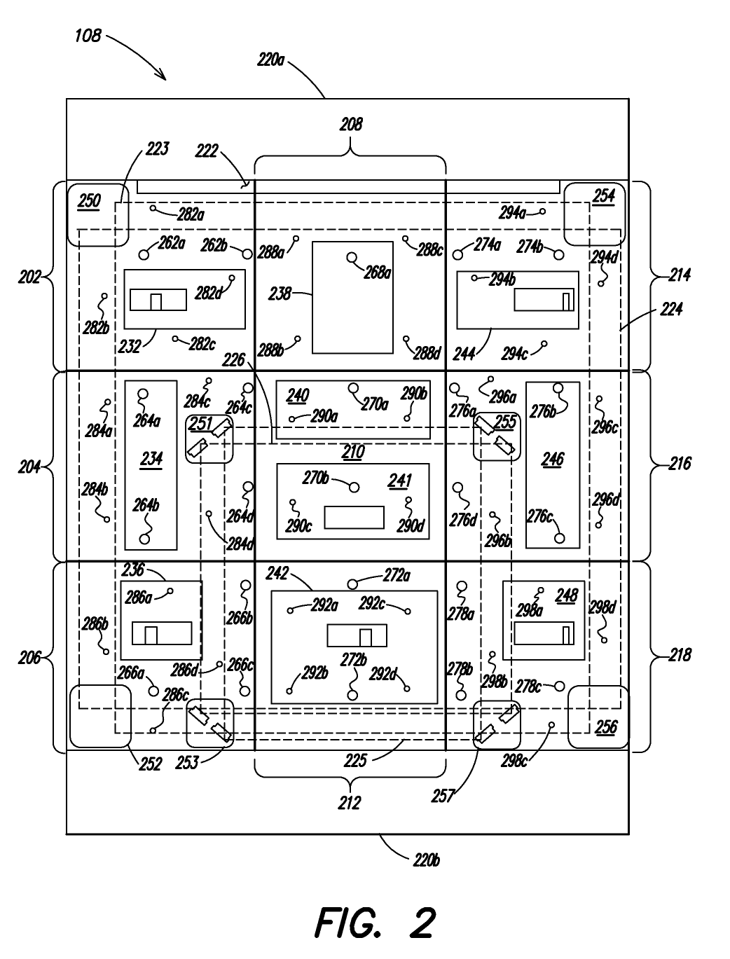

A perspective view of an exemplary inkjet printing system that may be employed in the context of the invention is shown in FIG. 1. The inkjet printing system 100 as a whole is supported by a frame structure 102 onto which a planar platform 104 may be movably coupled. The platform 104 may be coupled to a driving mechanism 106 which may include, for example, one or more rollers, belts, and/or other transmission devices driven by one or more motors (not shown). The platform 104 may be moved with respect to the frame structure 102 by the driving mechanism 106 in the Y-axis direction (into or out of the page as shown). A substrate support 108 adapted to secure a one more substrates (e.g., 60K and 20K substrates) 110, 112 may be coupled to the top surface of the platform 104. An exemplary embodiment of the substrate support 108 is described in greater detail below with respect to FIG. 2. It is noted that substrate supports are sometimes referred to by different terms in the relevant art including: ‘chuck’, ‘system chuck’, and ‘support stage’. The term ‘substrate support’ as used herein is meant to include all devices upon which a substrate is placed and supported in inkjet printing systems and is expressly intended to encompass the aforementioned alternative terms.

When driven, the platform 104 may convey the substrate support 108 and any substrates 110, 112 positioned thereon under a plurality of inkjet print heads 114, 115, 116 which are adapted to deposit ink into wells (e.g., pixel wells)(not shown) disposed on the substrates 110, 112. As described in previously incorporated U.S. patent application Ser. No. 11/521,177 (Attorney Docket No. 10502), the substrates 110, 112 may include black matrix material with which an array of pixel wells may be fabricated. The array of pixel wells disposed on the substrates 110, 112 allows specific amounts of different colors of ink to be deposited without blending, enabling a colored pattern to be produced on the substrates 110, 112. For example, each of the inkjet print heads 114, 115, 116 may be adapted to deposit a different color of ink, such as red (R), green (G) and blue (B) and may be operated so as to produce a color filter for a FPD including sets of Red/Green/Blue pixels on the substrates 110, 112. Other colors and combinations may be used.

The individual print heads 114, 115, 116 may be movable independently in the horizontal X-axis direction along a bridge support 118 and may each be rotatable about their respective central axes in the horizontal plane so as to deposit ink over the entire width of the substrates 110, 112 at different pitches (horizontal spacings). Additional adjustments may be effected by movement of the bridge support 118 in the Y-axis direction and/or rotation of the bridge support 118 in the horizontal plane as described in previously incorporated U.S. patent application Ser. No. 11/212,043 (Attorney Docket No. 9521-6). Such adjustments may be made to accommodate substrates that are oriented at different angles with respect to the X and Y axes.

It is noted that while only three print heads 114, 115, 116 are shown, the inkjet printing system 100 may include a greater number of inkjet print heads (e.g., 6, 9, 12 print heads) arranged on one or more bridge supports. For example, previously incorporated U.S. patent application Ser. No. 11/761,832 (Attorney Docket No. 11127), describes an inkjet printing system which includes four sets of inkjet print heads, in which each set includes three inkjet print heads, totaling twelve (12) inkjet print heads.

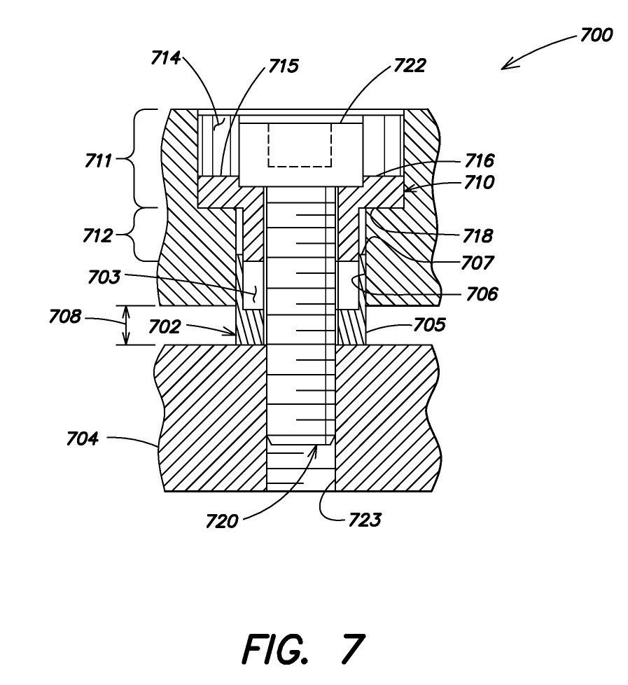

Referring to FIG. 2, an exemplary substrate support 108 according to an embodiment of the present invention is shown. In one or more embodiments, the entire surface are of the substrate support 108 may be on the order of approximately 2.7 meters width (X-axis direction) by approximately 2.7 meters length (Y-axis direction). However, the substrate support 108 may have other width and length dimensions. As discussed above, the surface area of a monolithic substrate support may be difficult to machine, grind or polish to the requisite flatness and/or uniformity. According to the invention, a modular substrate support 108 comprises a plurality of support tiles 202, 204, 206, 208, 210, 212, 214, 216, 218 which, individually, may be machined, ground, polished, etc. (‘flattened’), to the requisite flatness and uniformity. The individual support tiles 202, 204, 206, 208, 210, 212, 214, 216, 218 may then be installed together to form the substrate support 108 and leveled (e.g., raised, lowered, aligned, and/or tilted) with respect each other as described further below with respect to FIG. 7.

In the embodiment depicted in FIG. 2, the substrate support 108 includes nine (9) support tiles 202, 204, 206, 208, 210, 212, 214, 216, 218 arranged in a 3 by 3 configuration (three rows by three columns), in which each support tile has approximately the same shape and surface dimensions (i.e., width and length). In the depicted embodiment, the support tiles 202, 204, 206, 208, 210, 212, 214, 216, 218 may be approximately 0.9 m by 0.9 m. However, it is to be appreciated that a smaller or larger number of tiles may be used (e.g., 5, 6, 7, 8, 10, 11, 12, 13, 14, 15, 16) and the support tiles may have varied shapes and surface dimensions with respect to each other.

The substrate support 108 may also include a first spill tray 220a positioned at a first longitudinal end of the substrate support 108 coupled to support tiles 202, 208 and 214, and a second spill tray 220b positioned at a second longitudinal end of the substrate support 108 coupled to support tiles 206, 212 and 218. The top surfaces of spill trays 220a, 220b may be positioned slightly lower relative to the top surfaces of support tiles 202, 204, 206, 208, 210, 212, 214, 216, 218 such that the spill trays 220a, 220b may receive ink that spills off of the substrates 110, 112 and/or substrate support 108 during printing. Calibration glass 222 may be included on one or more edges of the substrate support 108 for the purpose of aligning a substrate (e.g., 60K substrate 110) on the substrate support 108. In the embodiment depicted, the calibration glass 222 is positioned at a top or back edge of the substrate support 108. The calibration glass 222 may provide a window for one or more optical devices (e.g., light sources, detectors, not shown) positioned under the substrate support 108 which may facilitate automatic or manual alignment of an edge of the 60K substrate 110. In one or more embodiments, upper support tiles 202, 208, 214 may be shaped or have portions removed to provide for the placement of the calibration glass 222.

The support tiles 202, 204, 206, 208, 210, 212, 214, 216, 218 may be made of a metal such as aluminum, or any other material having suitable (e.g., relatively light) weight, rigidity and support strength, so that the substrates 110, 112 positioned on substrate support 108 may be securely held in position, may be moved at suitable speeds (e.g., about 0.1 to 2 m/s), and may be brought to rest without causing damage to the substrates 110, 112. The support tiles 202, 204, 206, 208, 210, 212, 214, 216, 218 may also be coated, for example with an anti-stain surface treatment in order to reduce surface cleaning. In one or more embodiments, each support tile 202, 204, 206, 208, 210, 212, 214, 216, 218 may have a weight of about 45 kg to 60 kg. However, other weight tiles may be used.

The example substrate support 108 including support tiles 202, 204, 206, 208, 210, 212, 214, 216, 218 depicted in FIG. 2 is configured to support 60K standard-sized substrates in both 0 and 90 degree orientations (i.e., with the long dimension of the substrate aligned in the Y-axis direction, or in the X-axis direction). In the embodiment depicted in FIG. 2, 60K substrates 110 may be placed and secured at a first, zero (0) degree position 223 (shown in phantom) or at a second, ninety (90) degree position 224 (also shown in phantom) oriented perpendicularly with respect to the first position 223. As can be discerned the first and second positions 223, 224 encompass a substantial portion of the tiled area of the substrate support 108 and portions of each of the support tiles 202, 204, 206, 208, 210, 212, 214, 216, 218.

In some embodiments (as depicted), the substrate support may also be adapted to support 20K substrates 112 in a first zero (0) degree position 225 (shown in phantom) or at a second, ninety (90) degree position 226 (also shown in phantom) oriented perpendicularly with respect to the first position 225. 20K substrates 112 may be positioned at other locations and/or orientations on the substrate support 108. As can be discerned, the area covered by the respective first and second positions 225, 226 encompasses a smaller portion of the surface area of substrate support 108, including substantial portions of tiles 210 and 212 and smaller portions of tiles 204, 206, 210, 216 and 218.

Substrates 110, 112 may be secured in the first/second positions 223/224, 225/336 at least in part, by application of pneumatic (e.g., vacuum suction) and/or electrical (e.g., electrostatic) forces. The substrates 110, 112 may also be secured in the first and second positions 223/224, 225/226 by employing one or more mechanical or electro-mechanical clamping apparatuses as described further below.

In one or more embodiments, the support tiles 202, 204, 206, 208, 210, 212, 214, 216, 218 may include openings (e.g., holes, lines) that are coupled to a blower/vacuum source such as, for example, a pneumatic assembly (not shown), that may provide either an upward blower pressure or a downward suction force on substrates 110, 112 positioned over the openings. In particular, the support tiles 202, 204, 206, 208, 212, 214, 216, 218 may include respective blower/vacuum lines 232, 234, 236, 238, 242, 244, 246, 248 configured in rectangular arrangements of various sizes to provide suction over several portions of the substrates 110, 112. As shown, the central support tile 210 includes two sets of vacuum lines 240, 241 to promote stability in the center of the substrate support 108. Other pneumatic line configurations may be used.

In operation, when a substrate 110, 112 is placed on a substrate support, an upward pressure is applied via blower/vacuum lines 232, 234, 236, 238, 242, 244, 246, 248 so that the substrate 110 may float over the substrate 108, which enables the substrate 110 to be shifted more easily into a desired position. The blower/vacuum lines 232, 234, 236, 238, 240, 241, 242, 244, 246, 248 and pneumatic assembly may be adapted to provide an upward pressure of approximately 40 to 60 pounds per square inch (psi) although other pressure may be applied.

The substrate support 108 may include respective clamping apparatuses 250, 252, 254 and 256 (not shown in detail) adapted to secure respective upper left, lower left, upper right and lower right corners of substrate 110 in either the first or second position 223, 224. In some embodiments, the substrate support 108 may also include additional clamping apparatuses 251, 253, 255 and 257 adapted to secure respective upper left, lower left, upper right and lower right corners of substrate 112 in either the first or second position 225, 226.

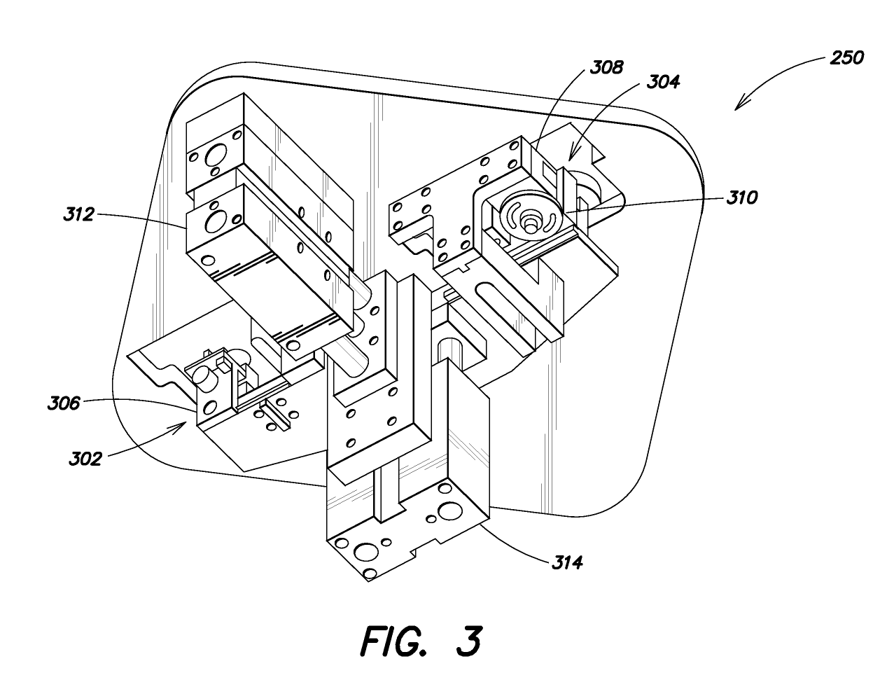

Referring to FIG. 3, an exemplary clamping apparatus (e.g., 250) that may be employed in the context of the present invention is shown in bottom perspective view. A clamping apparatus as described in commonly-assigned application Ser. No. 10/781,953 (Attorney Docket No. 8166) may also be used. The clamping apparatus 250 may include two clamping assemblies 302, 304, each including a stationary clamp mechanism and a rotational clamp mechanism. The stationary clamp mechanism in each clamping assembly 302, 304 is adapted to establish a reference position and act as a stop against which an edge (e.g., near a corner) of the substrate 110 may be forcibly secured. The rotational clamp mechanism in each clamping assembly 302, 304 is adapted to apply a force (e.g., in the plane of the substrate support 108) on an edge of the substrate 110. In one or more embodiments, the stationary clamp mechanism may include a banking pad (of which one is shown) 306 adapted to moved to and establish a reference position for the substrate 110. The rotational clamp mechanism may include a movable member such as a push pad 308 and a biasing device such as a spring 310 adapted to apply pressure to an edge of a substrate 110.

The clamping apparatus 250 may further include a first actuator 312 (e.g., pneumatic, electro-mechanical, etc.) adapted to move the banking pad 306 in a horizontal direction and a second actuator 314 adapted to move the banking pad 306 in a vertical direction. The first and second actuators 312, 314 may be operated so as to move the banking pad 306 into a reference position, to form a stationary boundary against which a corner edge of the substrate 110 may be clamped and secured. In one or more embodiments, the first actuator 312 is adapted to move the banking pad 306 about 10 mm in a horizontal direction and the second actuator 314 is adapted may move the banking pad 306 about 20 mm in a horizontal direction so as to establish an approximately ±10 mm capture range, repeatable up to about within 0.5 mm. Other ranges may be used.

In operation, to define the area(s) 223, 224 in which the substrate 110 is intended to be secured, three reference positions, which together define a plane, may be selected. The reference positions correspond to the locations of three stationary clamping mechanisms of the clamping apparatuses 250, 252, 254, 256. The three stationary clamping mechanisms (out of eight possible mechanisms) are actuated to move banking pads (e.g., 306) to the three selected reference positions. In some embodiments, the three stationary clamping mechanisms used to establish the reference positions may be selected from clamping apparatus 250, 252 and 254 (on the upper left, lower left and upper right corners, respectively), but preferably not from clamping apparatuses 250 and 254 solely, in which case all of the reference positions would be on the same (upper) edge of the substrate 110.

In an exemplary clamping process, after a substrate 110 has been placed on the substrate support 108, an upward pressure may be applied via blower or vacuum lines 232, 234, 236, 238, 240, 241, 242, 244, 246, 248, allowing the substrate 110 to float over the substrate support 108. A banking pad 306 of clamping apparatus 250 may be raised over the substrate 110 and moved to a first reference position near the upper left corner of the substrate 110, a banking pad of clamping apparatus 252 may be raised over the substrate 110 and moved to a second reference position near the lower left corner of the substrate 110 and a banking pad of clamping apparatus 254 may be raised over the substrate 110 and moved near a third reference position at the upper right corner of substrate 110. It is noted that other stationary clamping mechanisms of the same or other clamping apparatuses may be used. In addition, one or both of the clamping mechanisms (stationary and/or rotational) of a clamping apparatus (e.g., 302, 304) may be used in a given clamping operation.

Once the banking pads have been moved to establish reference positions, as the substrate 110 is floating, rotational clamping mechanisms of the same or other clamping apparatuses 250, 252, 254, 256 may be actuated to apply force onto edges of the substrate 110 (e.g., near the corners) so as to urge the substrate 110 into contact with the banking pads in the reference positions, thus clamping the substrate 110 in the aligned position (e.g., 223) on the substrate support 108. The substrate 110 may be forcibly maintained in the aligned position by the biasing action of springs in the rotational clamping mechanisms (e.g., 310).

Once the substrate 110 has been clamped, the upward pressure through blower or vacuum lines 232, 234, 236, 238, 240, 241, 242, 244, 246, 248 may be turned off, and a downward suction force may be activated. In this manner, the substrate 110 is secured by both mechanical clamping and pneumatic suction and may be maintained precisely in a preset, aligned position and orientation even during rapid and/or abrupt movements of the substrate support 108 (e.g., during a printing run).

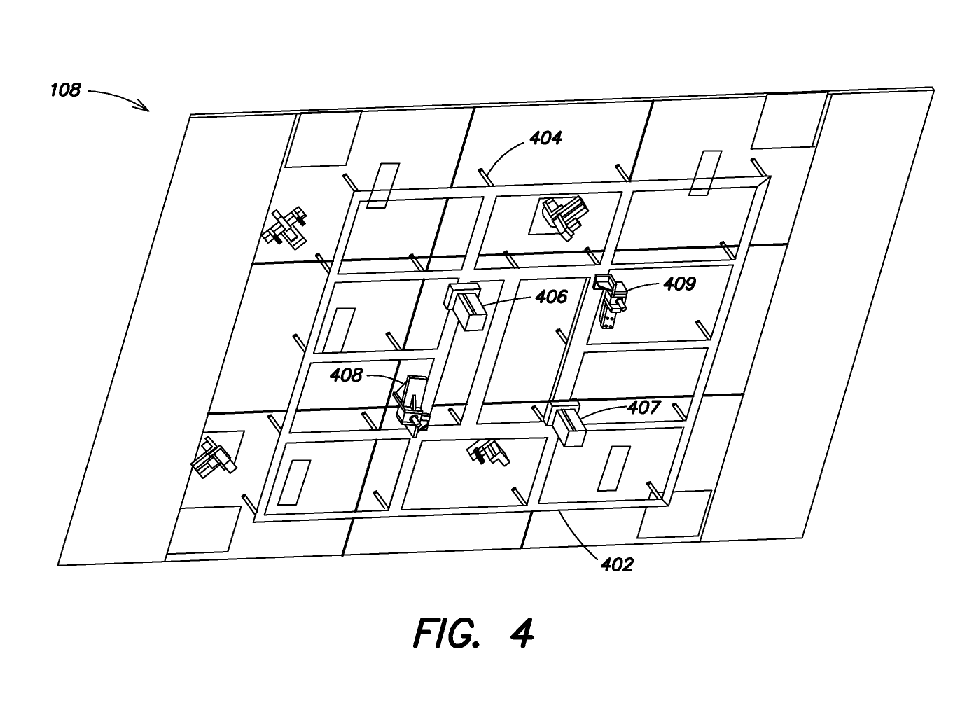

Referring now to FIG. 4, which depicts a bottom perspective view of the substrate support 108, a lift frame 402 may be positioned between the movable platform 104 and the substrate support 108 and may be adapted to lift substrates 110, 112 off of the substrate support 108 using lift pins 404 (only one labeled) coupled (e.g., rigidly attached) to the lift frame 402. Each of the support tiles 202, 204, 206, 208, 210, 212, 214, 216, 218 (FIG. 2) may include respective lift pin openings 262a-b, 264a-d, 266a-c, 268a, 270a-b, 272a-b, 274a-b, 276a-d, 278a-c through which lift pins 404 may extend through the tiles 202, 204, 206, 208, 210, 212, 214, 216, 218 into contact with a substrate 110, 112 positioned on the substrate support 108. Thus, in the particular depicted example embodiment, the substrate support 108 accommodates, through openings in the support tiles, the use of twenty-three (23) lift pins 404. It is noted however, that other configurations and numbers of lift pin openings may be used to accommodate a different number and configuration of lift pins 404.

The lift frame 402 and lift pins 404 may be lifted by action of one or more actuators 406, 407 coupled to the lift frame 404. The lift frame 402 may be coupled to the substrate support 108 by bearings (e.g., linear bearings) 408, 409. Although two actuators 406, 407 and bearings 408, 409 are shown, a larger or smaller number of actuators and bearings may be used (e.g., 1, 3, 4, 5). In some embodiments, the actuators 406, 407 may be pneumatically-driven and may be coupled to the pneumatic assembly (not shown) provided for the operation of the vacuum lines. In additional or alternative embodiments, the actuators 406, 407 may be electrically or electromechanically driven, e.g., via one or more motors.

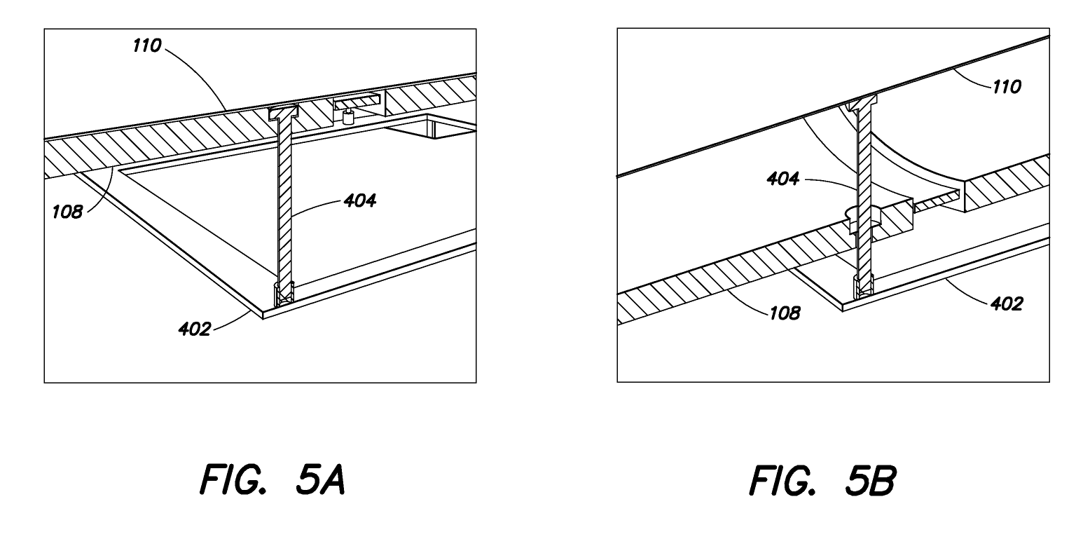

In operation, when a substrate 110, 112 is to be installed on or removed from the inkjet printing system 100, the actuators 406, 407 may be driven to exert an upward force on the lift frame 402 (at one or more points on the frame), which may move the lift frame 402 from a rest or ‘down’ position to an ‘up’ position. The upward movement of the lift frame 402 in turn causes lift pins 404 to move in an upward stroke through openings 262a-b, 264a-d, 266a-c, 268a, 270a-b, 272a-b, 274a-b, 276a-d, 278a-c. The upward stroke of the lift pins 404, which may be about 125 mm in length (other lengths may be used), is sufficient to force the substrate 110, 112 off of the substrate support 108 so as to allow a robot end effector or other suitable device to remove the substrate 110, 112 from the substrate support 108. The substrates 110, 112 may be supported by the lift pins 404 above the substrate support 108 by approximately the length of the upward stroke. Other stroke lengths and speeds may be used. FIGS. 5A and 5B illustrate the respective ‘down’ and ‘up’ positions in cross-sectional perspective view and show relative change from the ‘down’ position in which a substrate (e.g., 110) rests upon the substrate support 108 (shown in FIG. 5A) to the ‘up’ position in which the substrate 110 is raised by the lift pins 404 above and off of the substrate support 108 (shown in FIG. 5B). In alternative embodiments, other apparatuses and techniques may be used to lift a substrate 110 from the substrate support 108 such as using one or more robot arms, grippers, etc.

As noted above, each of the support tiles 202, 204, 206, 208, 210, 212, 214, 216, 218 may be flattened before being installed on the substrate support 108. Upon installation, the support tiles 202, 204, 206, 208, 210, 212, 214, 216, 218 may then be leveled with respect to each other to achieve a flat, level, and co-planar surface across the entire substrate support 108. According to some embodiments of the invention, each of the support tiles 202, 204, 206, 208, 210, 212, 214, 216, 218 may include one or more level adjustment mechanisms (‘leveling mechanisms’) adapted to adjust the level at one or more points on the support tiles 202, 204, 206, 208, 210, 212, 214, 216, 218. In the exemplary embodiment of the substrate support 108 depicted in FIG. 2, a number of leveling mechanisms are shown. As depicted, leveling mechanisms 282a-d, 284a-d, 286a-d, 288a-d, 290a-d, 292a-d, 294a-d, 296a-d and 298a-d are positioned on and adapted to level respective support tiles 202, 204, 206, 208, 210, 212, 214, 216, 218.

As depicted, each support tile 202, 204, 206, 208, 210, 212, 214, 216, 218 may include four (4) leveling mechanisms. The use of a plurality of leveling mechanisms allows each support tile to be raised or lowered at more than one point on a support tile surface. However, it is noted that a larger or smaller number of leveling mechanisms may be used (e.g., 1, 2, 3, 5, 6, etc.). The leveling mechanisms may be operated automatically using actuators (not shown) or manually (as shown and described below).

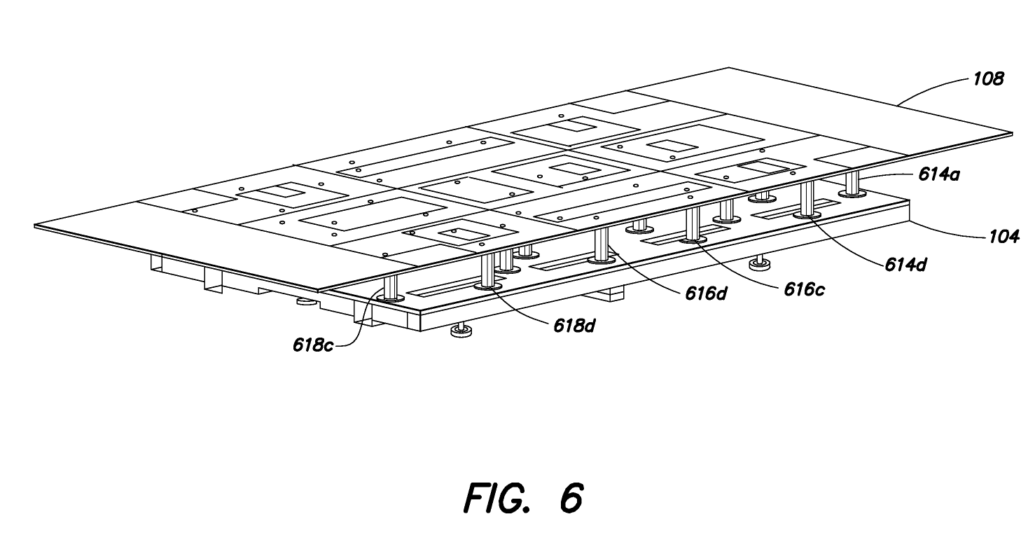

Each of the leveling mechanisms 282a-d, 284a-d, 286a-d, 288a-d, 290a-d, 292a-d, 294a-d, 296a-d, 298a-d coupled to support tiles 202, 204, 206, 208, 210, 212, 214, 216, 218 may also be coupled to one or more base supports which may comprise a plate, frame, post or the like, and which may serve as a fixed reference point for the operation of the leveling mechanisms and also as a support. FIG. 6 is a perspective view of an exemplary substrate support 108 and planar platform 104 according to an embodiment of the invention. As shown, each of the support tiles 202, 204, 206, 208, 210, 212, 214, 216, 218 rest on a respective plurality of posts 602a-d, 604a-d, 606a-d, 608a-d, 610a-d, 612a-d, 614a-d, 616a-d, 618a-d, which, in turn, are fixedly coupled to the planar platform 104. In at least one embodiment of the invention, each one of the leveling mechanisms 282a-d, 284a-d, 286a-d, 288a-d, 290a-d, 292a-d, 294a-d, 296a-d, 298a-d, is coupled to one of the respective posts 602a-d, 604a-d, 606a-d, 608a-d, 610a-d, 612a-d, 614a-d, 616a-d, 618a-d. However, other arrangements for coupling the leveling mechanisms 282a-d, 284a-d, 286a-d, 288a-d, 290a-d, 292a-d, 294a-d, 296a-d, 298a-d may be employed.

FIG. 7 is a cross-sectional view of an example of a leveling mechanism 700 that may be used with the inventions disclosed herein. In the depicted embodiment, the leveling mechanism 700 may include an AFAB™ alignment kit manufactured by and commercially available from Silicon Valley Automation of Forney, Tex. In some embodiments, each of the leveling mechanisms 282a-d, 284a-d, 286a-d, 288a-d, 290a-d, 292a-d, 294a-d, 296a-d, 298a-d discussed above with respect to FIG. 2 may include similar leveling mechanisms 700. In additional and/or alternative embodiments, other leveling mechanisms may be used. The leveling mechanism 700 may include an annular threaded adjustment member 702 having a hollow portion 703 which is adapted to rest on a fixed base 704 (such as posts 602a-d, etc., shown in FIG. 6) at a first end 705, and to extend into an opening 706 of a support tile 202 at a second end 707 such that a gap 708 is maintained between the surface of the fixed base 704 and the surface of the support tile 202 opposite the surface of the fixed base 704.

An annular keyed adjustment member 710 may be positioned in the opening 706 of the support tile 202 above the threaded adjustment member 702. The keyed adjustment member 710 includes a first section 711 having a first outer annular radius, and a second portion 712 having a second outer annular radius smaller than the outer annular radius of the first section 711. It is to be appreciated that the opening 706 in the support tile 202 includes corresponding portions of different diameters to accommodate the first and second sections 711, 712 of keyed adjustment member 710.

The first section 711 of the keyed adjustment member 710 may include a hollow portion 714 adapted to receive an adjustment tool and a solid portion 715 situated under the hollow portion 714. Toward the opposite end of the first section 711 from the hollow portion 714, a flange 716 is formed at the conjunction of the first and section sections 711, 712 of the keyed adjustment member 710. The flange 716 rests on a corresponding ledge 718 formed in the opening 706 of the support tile 202 formed where the wider and narrower portions of the opening 706 meet.

The second section 712 of the keyed adjustment member 710 is adapted to extend into the hollow portion 703 of the threaded adjustment member 702. A screw 720 having a head 722 adapted to receive a tightening tool (e.g., an Allen wrench) may be positioned to extend through both the keyed adjustment member 710 and the threaded adjustment member 702 into the fixed base 704, which may include a corresponding threaded opening 723 to receive the screw 720. The head 722 of the screw 720 is adapted to contact the first section 711 of the keyed adjustment member 710 while a bottom portion of the screw 720 may be threadably coupled to the threaded adjustment member 702 and fixed base 704.

In operation, after the support tiles 202, 204, 206, 208, 210, 212, 214, 216, 218 have been flattened and assembled on a substrate support 108, the leveling mechanisms 282a-d, 284a-d, 286a-d, 288a-d, 290a-d, 292a-d, 294a-d, 296a-d, 298a-d may be inserted into the support tiles 202, 204, 206, 208, 210, 212, 214, 216, 218 and then adjusted to level the entire surface of the substrate support 108.

The insertion and adjustment of an individual leveling mechanism 700 may proceed as follows. The threaded adjustment member 702 and keyed adjustment member 710 are inserted into opening 706 in a support tile (e.g., 202). The screws 720 may then be inserted and threaded into the fixed base 704 preferably without substantially tightening the screw 720. An adjustment tool (not shown) may then be inserted into the hollow portion 714 of the first section 711 of the keyed adjustment member 710. The adjustment tool engages the solid portion 715 of the first section 711 of the keyed adjustment member 710 and the screw 720. By turning the adjustment tool, a downward pressure may be brought to bear on the head 722 of the screw 720 and the solid portion 715 of the first section 711 of keyed adjustment member 710. In response to the application of downward pressure, solid portion 715 may move through the hollow portion 703 of the threaded adjustment member 702. Downward movement of the solid portion 715 is directly translated to the support tile 202 as downward pressure of the flange 716 acts on the ledge 718 in opening 706 causing a corresponding downward movement of the support tile 202, reducing the gap 708 between the support tile 202 and the fixed base 704. In this manner, the gap 708 may be adjusted to a desired level. Once the desired gap level has been reached, the screw 720 may be tightened to secure the components of the leveling mechanism 700 in place. It is noted that while the exemplary leveling process described which employs the depicted mechanical leveling mechanism 700 is a manual process, other leveling mechanisms may be used which may, for example, function automatically using sensors and actuators which may, for example, employ open or closed-loop feedback to reach a desired gap level.

As a support tile 202 may include a plurality of leveling mechanisms 700 at separate locations, the support tile 202 may be leveled by setting the gap 708 at each location to the same level. The same principal applies to the entire substrate support 108 as the plurality of support tiles 202, 204, 206, 208, 210, 212, 214, 216, 218 may be adjusted via their respective leveling mechanisms so as to initially set the gap between the support tiles and the fixed bases positioned under each support to the same level. In one or more embodiments, the leveling mechanism 700 and/or the support tiles 202, 204, 206, 208, 210, 212, 214, 216, 218 may be equipped with a level indicator (not shown) adapted to indicate whether or not an individual support tile has been leveled. The level indicator may comprise, for example, a bubble encased in fluid, or any other suitable level sensor (e.g., an optical sensor including an interferometry device which may detect misalignment, etc.).

It is noted that the respective fixed bases positioned under the support tiles 202, 204, 206, 208, 210, 212, 214, 216, 218 (e.g., posts 602a-d, 604a-d, 606a-d, 608a-d, 610a-d, 612a-d, 614a-d, 616a-d, 618a-d) may not be precisely the same height. In this case, to achieve a level substrate support 108 surface, the gaps between the support tiles 202, 204, 206, 208, 210, 212, 214, 216, 218 and their respective fixed bases 704 may be adjusted to different levels to accommodate the different heights of the bases. Since the correct gaps may not be precisely known in advance, the same or additional level indicators may also be incorporated on the substrate support 108 to indicate whether one or more support tiles have or have not been leveled with respect to each other.

The foregoing description discloses only exemplary embodiments of the invention. Modifications of the above disclosed apparatus and method which fall within the scope of the invention will be readily apparent to those of ordinary skill in the art. For instance, the substrate support may accommodate and/or include a maintenance module adapted to treat the inkjet print heads, and a vision microscope and/or a drop visualization system adapted to ensure proper printing alignment.

Further, the present invention may also be applied to spacer formation, polarizer coating, and nanoparticle circuit forming.

Accordingly, while the present invention has been disclosed in connection with exemplary embodiments thereof, it should be understood that other embodiments may fall within the spirit and scope of the invention, as defined by the following claims.

The invention claimed is:

1. A substrate support comprising:
a first major surface comprising a plurality of flat support tiles; and
a plurality of leveling mechanisms coupled to the plurality of support tiles;
wherein the plurality of leveling mechanisms are adapted to level the plurality of flat support tiles with respect to each other so as to provide a flat and level first major surface of the substrate support.

2. The substrate support of claim 1, wherein at least three leveling mechanisms are coupled to each of the plurality of support tiles.

3. The substrate support of claim 1, wherein the plurality of leveling mechanisms are operated manually.

4. The substrate support of claim 1, wherein the plurality of leveling mechanisms are operated automatically.

5. The substrate support of claim 1, wherein the first major surface of the substrate support has an area sufficiently large to support a 60K substrate in both a first orientation and in a second orientation perpendicular to the first orientation.

6. The substrate support of claim 1, wherein each of the plurality of support tiles includes openings adapted to couple to a pneumatic assembly so as to provide suction for securing a substrate on the first major surface of the substrate support.

7. The substrate support of claim 1, further comprising:
a plurality of clamping apparatuses adapted to secure a substrate in place on the major surface of the substrate support in both a first orientation and in a second orientation perpendicular to the first orientation.

8. The substrate support of claim 7, wherein each of the plurality of clamping apparatuses comprises at least one stationary clamp mechanism adapted to establish a reference position for securing a corner of the substrate and at least one rotating clamping mechanism adapted to move the substrate.

9. The substrate support of claim 1, further comprising:
a lift frame coupled to a second major surface of the substrate support opposite the first major surface; and
a plurality of lift pins coupled to the lift frame;
wherein the lift frame is adapted to move the lift pins toward or away from the second major surface of the substrate support.

10. The substrate support of claim 9, wherein each the plurality of support tiles include openings positioned to receive the plurality of lift pins, enabling the lift pins to penetrate through and above the first major surface of the substrate support.

11. The substrate support of claim 10, wherein the lift pins may be operated so as to lift or lower a substrate positioned on the first major surface of the substrate support.

12. An inkjet printing system comprising:
a movable platform;
a substrate support coupled to the moving platform including:
a first major surface comprising a plurality of flat support tiles; and
a plurality of leveling mechanisms coupled to the plurality of support tiles; and
a plurality of inkjet print heads adapted to deposit ink onto a substrate positioned on the first major surface of the substrate support;
wherein the plurality of leveling mechanisms are adapted to level the plurality of flat support tiles with respect to each other so as to provide a flat and level first major surface of the substrate support.

13. The inkjet printing system of claim 12, wherein the first major surface of the substrate support has an area sufficiently large to support a 60K substrate in both a first orientation and in a second orientation perpendicular to the first orientation.

14. The inkjet printing system of claim 12, wherein each of the plurality of support tiles includes openings adapted to couple to a pneumatic assembly so as to provide suction for securing a substrate on the first major surface of the substrate support.

15. The inkjet printing system of claim 12, wherein the movable platform includes a plurality of posts adapted to support the plurality of leveling mechanisms.

16. The inkjet printing system of claim 12, wherein the substrate support includes a plurality of clamping apparatuses adapted to secure a substrate in place on the major surface of the substrate support in both a first orientation and in a second orientation perpendicular to the first orientation.

17. The inkjet printing system of claim 12, wherein the substrate support includes:
a lift frame coupled to a second major surface of the substrate support opposite the first major surface; and
a plurality of lift pins coupled to the lift frame;
wherein the lift frame is adapted to move the lift pins toward or away from the second major surface of the substrate support.

18. The inkjet printing system of claim 17, wherein each the plurality of support tiles include openings positioned to receive the plurality of lift pins, enabling the lift pins to penetrate through and above the first major surface of the substrate support, and the lift pins may be operated so as to lift or lower a substrate positioned on the first major surface of the substrate support.

19. A method of supporting a substrate comprising:
providing a plurality of support tiles, each of the plurality of support tiles having an area sufficiently small to enable the support tiles to be flattened;
flattening the plurality of support tiles;
combining the plurality of flat support tiles so as to form a substrate support; and
leveling the plurality of support tiles on the substrate support so as to provide a flat and level major surface of the substrate support.

20. The method of claim 19, further comprising:
applying pneumatic suction to secure a substrate on the major surface of the substrate support.

21. The method of claim 20, further comprising:
mechanically clamping the substrate on the major surface of the substrate support before applying the pneumatic suction.

22. The method of claim 19, wherein the plurality of support tiles include openings adapted to enable at least one lifting member to penetrate though and above the major surface of the substrate support.

23. The method of claim 22, further comprising:
lifting or lowering a substrate positioned on the major surface of the substrate support using the at least one lifting member.

24. The method of claim 23, wherein the at least one lifting member comprises a plurality of lift pins.
